(19) United States
(12) Patent Application Publication
(10) Pub. No.: US 2009/0254615 A1
(43) Pub. Date: Oct. 8, 2009

(54) APPARATUS, SYSTEM, AND METHOD FOR MANAGING COLLABORATIVE SHARING BY INVITEES TO A MEETING OF THEIR MEETING STATUS

(75) Inventors: Priya Baliga, San Jose, CA (US); Lydia M. Do, Research Triangle Park, NC (US); Mary P. Kusko, Hopewell Junction, NY (US); Fang Lu, Billerica, MA (US)

Correspondence Address: Kunzler & McKenzie, 8 EAST BROADWAY, SUITE 600, SALT LAKE CITY, UT, 84111, US

(73) Assignee: International Business Machines Corporation, Armonk, NY (US)

(21) Appl. No.: 12/062,332

(22) Filed: Apr. 3, 2008

(51) Int. Cl. G06F 15/16

(52) U.S. Cl. 709/204

(57) ABSTRACT

An apparatus, system, and method are disclosed for allowing a particular invitee to a meeting to control the distribution of information about the particular invitee's posture with respect to the meeting that determines a plurality of invitees to the meeting from a meeting invitation, selects invitees to the meeting from the plurality of invitees to the meeting based on criteria in a meeting profile unique to the particular invitee, generates a message to the selected invitees disclosing the status of the particular invitee relative to the meeting, and provides the message to the selected invitees.

### BACKGROUND OF THE INVENTION

1. Field of the Invention

This invention relates to applications used to coordinate meetings and more particularly relates to applications used to manage meeting status of invitees to a meeting by the invitees.

2. Description of the Related Art

Calendaring and scheduling applications are useful in keeping track of tasks, meetings, events, and appointments generally. The utility of such applications is greatly increased when they are configured to not only keep track of appointments, but to facilitate the making of the very appointments they track. An email client, an integral part of many calendaring and scheduling applications, can be used to facilitate the making of appointments and meetings.

Currently, calendaring and scheduling applications allow a meeting organizer or chair to view whether meeting invitees have accepted or declined an invitation to a meeting. In such applications, all remaining potential participants in the meeting are provided no avenue for viewing which invitees have accepted and which invitees have declined to attend the meeting. The inability of potential participants to view the status of other potential participants is a major drawback of these applications.

Knowing who plans to attend a meeting and other bits of information about potential attendees often constitutes important information that an invitee would like to have before deciding to commit to a meeting. To obtain this important information in traditional collaborative calendaring and scheduling applications, an invitee would have to share his entire calendar. Not only is such a solution awkward, it requires the disclosure of information that is potentially private or otherwise inappropriate for general consumption.

Another approach to providing meeting status information to meeting invitees involves a web application. The web application facilitates the creation of a meeting invitation that lets the meeting organizer determine whether or not to allow invitees to see if other invitees have accepted or declined the meeting invitation. However, such a web application provides only a crude level of control to a meeting invitee over the distribution of the invitee's status with respect to the meeting.

With the aid of such a web application, an invitee is unable to manage the distribution of the invitee's meeting information. The organizer either chooses to inform all other invitees of the each invitee's decision to accept or decline, or the organizer does not. Such a web application does not allow an invitee to select which invitees receive the invitee's meeting information. Additionally, such a web application does not allow the invitee to determine to provide or not provide information about the invitee's status as an invitee and the role the invitee would play at the meeting, in addition to the invitee's attendance status. Furthermore, such a web application does not provide the invitee with an ability to set rules about the distribution of meeting information in response to an invitation or a request for information.

### SUMMARY OF THE INVENTION

From the foregoing discussion, it should be apparent that a need exists for an apparatus, system, and method that allows an invitee to manage the invitee's meeting information while collaborating in the making of a meeting. Beneficially, such an apparatus, system, and method would allow the invitee to select other invitees to have access to or select other invitees to deny access to the invitee's meeting information, should allow the invitee to determine the content of that information, and/or should allow the invitee to set rules for the distribution of the information in response to receiving an invitation or request for information. In certain embodiments, the apparatus, system, and method should involve a web application.

The present invention has been developed in response to the present state of the art, and in particular, in response to the problems and needs in the art that have not yet been fully solved by currently available calendaring and scheduling applications and/or web applications. Accordingly, the present invention has been developed to provide an apparatus, system, and method for managing collaborative sharing by invitees to a meeting of their meeting status that overcome many or all of the above-discussed shortcomings in the art.

A computer program product to allow an invitee to a meeting to control the distribution of information about the invitee's posture with respect to the meeting to other invitees is provided with a plurality of modules configured to functionally execute the necessary steps of determining who is invited to a meeting from a first meeting invitation to a first invitee to the meeting, selecting a second invitee to the meeting by a set of criteria rules, associating a level of visibility of the first invitee relative to the meeting with a second meeting invitation to the second invitee, providing the second meeting invitation to the second invitee. These modules in the described embodiments include a meeting determination module, an invitee selection module, a status management module, and a notice module.

In one embodiment, the second meeting invitation comprises an icon indicative of a social network relationship between the first invitee and the second invitee. Additionally, the set of criteria rules used by the invitee selection module of the computer program product, in one embodiment, involves an ordered set of criteria rules that include a tiered set of inclusion and/or exclusion rules from a group of criteria rules based on who is invited, invitees also belonging to a social network of the first invitee, invitees that share a role at the meeting, invitees having a common attribute, invitees who have met a condition defined by the first invitee, and individual invitee selections.

The set of criteria rules used by the invitee selection module of the computer program product, in one embodiment, is further defined by the first invitee as a default, in response to a particular meeting invitation, for a particular type of meeting invitation, for all meetings to which a particular invitee is invited, and for all meetings created by a particular meeting organizer.

A system of the present invention is also presented to allow an invitee to a meeting to control the distribution of information about the invitee's posture with respect to the meeting to other invitees. The system may be embodied to include a first scheduling application, a second scheduling application, a server, a meeting determination module, an invitee selection module, a status management module, a notice module, and a network connecting the first scheduling application, the second scheduling application, and the server. The aforementioned modules are coupled to the server and are configured to functionally execute the necessary steps of determining that a second invitee using the second scheduling application is invited to a meeting from a meeting invitation to a first invitee using the first scheduling application. The necessary steps include selecting the second invitee by an ordered set of criteria rules described above with respect to one embodiment of the computer program product, associating a level of visibility of the first invitee relative to the meeting with a second meeting invitation to the second invitee, and providing the second meeting invitation to the second invitee through the second scheduling application via the network.

In particular, the status management module of the system, in one embodiment, allows the first invitee to determine a level of visibility of the first invitee relative to the meeting that may include one or more of visibility of the first invitee's listing as an invitee to the meeting, visibility of the first invitee's attendance status with respect to the meeting, and visibility of the first invitee's role at the meeting. In certain embodiments, the meeting profile allows the first invitee to select a second invitee, based on the second invitee belonging to a particular group or social network, to receive a request for an update from the notice module in the event that the second invitee changes the second invitee's posture with respect to the meeting or the second invitee's level of visibility with respect to the first invitee.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for managing meeting-status information in accordance with the present invention; and

FIG. 2 is a schematic flow chart diagram illustrating one embodiment of a computer program product for managing meeting-status information in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

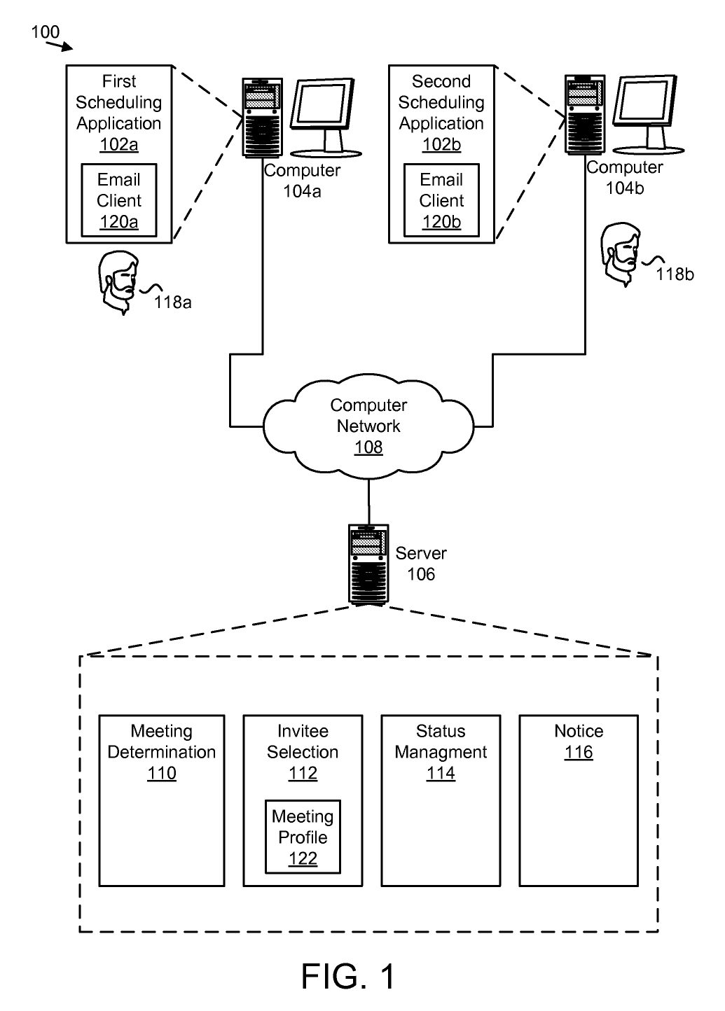

FIG. 1 depicts one embodiment of a system 100 for managing meeting-status information in accordance with the present invention. The system 100 includes a first scheduling application 102a, a second scheduling application 102b, a server 106, and a computer network 108. Coupled to the server 106 are a meeting determination module 110, an invitee selection module 112, a status management module 114, and a notice module 116. The various components of the system 100 cooperate to allow an invitee 118a to a meeting to control the distribution of information about the invitee's 118a posture with respect to the meeting to other invitees 118. An invitee's posture with respect to a meeting may include information about an invitee's 118 status as an invitee 118, an invitee's 118 planned attendance status, and an invitee's 118 role at the meeting.

Associated with the first scheduling application 102a is a first invitee 118a to a meeting. Similarly, the second scheduling application 102b has an associated second invitee 118b. In many embodiments, the system 100 includes more than two invitees 118 and more than two scheduling applications 102. The first scheduling application 102a and the second scheduling application 102b reside on computer readable memory and are executed by a processor pertaining to a first computer 104a and a second computer 104b corresponding to the first scheduling application 102a and the second scheduling application 102b, respectively. In many embodiments, there are more than two computers 104 corresponding to more than two scheduling applications 102. Each computer 104 may be a mainframe, a personal computer, a notebook computer, a personal digital assistant, a cell phone, and the like.

In certain embodiments, the first scheduling application 102a and the second scheduling application 102b reside on computer readable memory and are executed by a processor pertaining to a server 106. For example, the first scheduling application 102a and the second scheduling application 102b may comprise web applications or web services. Each scheduling application 102 includes at least software for keeping track of appointments and meetings and may optionally include an email client 120 for managing email. The computer network 108 may include, but is not limited to, a local area network, a wide area network, a wireless network, a fiber channel network, the Internet, or the like, and may include one or more different network types.

In certain embodiments, the email client 120a of the first scheduling application 102a receives a first meeting invitation over the computer network 108. The first meeting invitation may be created by meeting information provided to a special interface, or the first meeting invitation may be created as an email. Those of ordinary skill in the art will recognize additional possibilities.

The meeting determination module 110 also receives the first meeting invitation through the network 108. The meeting determination module 110, coupled to the server 106, determines a plurality of invitees 118 to the meeting from meeting information in the first meeting invitation directed to the first invitee 118a. Included among the plurality of invitees 118 is the second invitee 118b. In certain embodiments, the plurality of invitees 118 includes more invitees 118 than just the second invitee 118b.

The invitee selection module 112, also coupled to the server 106, selects the second invitee 118b from the plurality of invitees 118. The invitee selection module 112 selects the second invitee 118b because the second invitee 118b meets at least one criterion from a set of criteria rules that the invitee selection module 112 uses to select invitees 118. In many embodiments, the invitee selection module 112 selects two or more invitees 118 from the plurality of invitees 118 to the meeting determined by the meeting determination module 110 because two or more of the invitees 118 meet at least one criterion from the set of criteria rules. In some embodiments, the invitee selection module 112 selects no invitee 118 because no invitee 118 meets any of the criterion rules or every invitee is excluded by at least one criterion rule. In certain embodiments, the set of criteria rules comprises an ordered set of criteria rules determined by the first invitee 118a from a group of criteria rules discussed below.

The set of criteria rules are defined by a meeting profile 122 unique to the first invitee 118a. A meeting profile allows a first possible invitee 118s to set criteria rules to select additional invitees 118 to receive information about the first invitee's 118a posture with respect to the meeting, where the information defining that posture is also determined by the first invitee 118a in the meeting profile 122. In certain embodiments, invitees 118 other than the first invitee 118a have a unique meeting profile 122 that the invitee selection module 112 uses to make selections for these other invitees 118, aside from the first invitee 118a. The first invitee 118a selects the criteria rules via an interface (not shown) provided to the meeting profile 122. In certain embodiments, the meeting profile 122 is a part of the invitee selection module 112. Those of ordinary skill in the art will be able to locate the meeting profile 122 in other components of the system 100 in light of the current disclosure.

The status management module 114, coupled to the server 106, associates a level of visibility of the first invitee 118a relative to the meeting with a second meeting invitation to the second invitee 118b. A level of visibility of an invitee 118 with respect to a meeting may or may not disclose that the invitee 118 is an invitee 118, the level of information about the invitee's 118 status as an invitee 118 to the meeting and/or whether the invitee 118 plans to attend the meeting, and/or the invitee's 118 role at the meeting.

In many embodiments, where the invitee selection module 112 selects two or more invitees 118, the status management module 114 associates a level of visibility of the first invitee 118a relative to the meeting with additional meeting invitations to each of the two or more invitees 118. In many of these embodiments, the status management module 114 also associates a level of visibility of each of the two or more additional invitees 118 relative to the meeting with meeting invitation to every other invitee 118. A level of visibility of the first invitee 118a with respect to the meeting is selected by the first invitee 118a. In certain embodiments, the first invitee 118a selects the level of visibility through an interface (not shown) provided to the meeting profile 122. In certain embodiments, two or more invitees 118 select a level of visibility particular to themselves relative to the meeting in a unique meeting profile.

Depending on the embodiment, the first invitee 118a, or the two or more invitees 118, may select a level of visibility that comprises one or more of visibility of the selecting invitee's 118 listing as an invitee 118 to the meeting, visibility of the selecting invitee's 118 attendance status with respect to the meeting (indicating whether the selecting invitee 118 has accepted the invitation, declined the invitation, or, in certain embodiments, is likely or unlikely to attend), and visibility of the selecting invitee's 118 role at the meeting.

The notice module 116, also coupled to the server 106, provides the second meeting invitation to the second invitee 118b. In certain embodiments, the notice module 116 provides the second meeting invitation to the second invitee 118b through the email client 120b of the second scheduling application 102b. In many embodiments, where the invitee selection module 110 selects two or more invitees 118 and the status management module 114 associates a level of visibility for each of the two or more invitees 118 relative to the meeting with meeting invitations particular to each of the two or more invitees 118, the notice module 116 provides each meeting invitation to its corresponding invitee 118 through the computer network 108.

In certain embodiments, the meeting profile 122 allows the possible first invitee 118a to select a second invitee 118b to receive a request for an update from the notice module 116 in the event that the second invitee 118b should change the second invitee's 118b posture with respect to the meeting or the second invitee's 118b level of visibility with respect to the first invitee 118a. The meeting profile 122 provides an interface that allows the first invitee 118a to select a second invitee 118b based on the second invitee belonging to a particular group or social network.

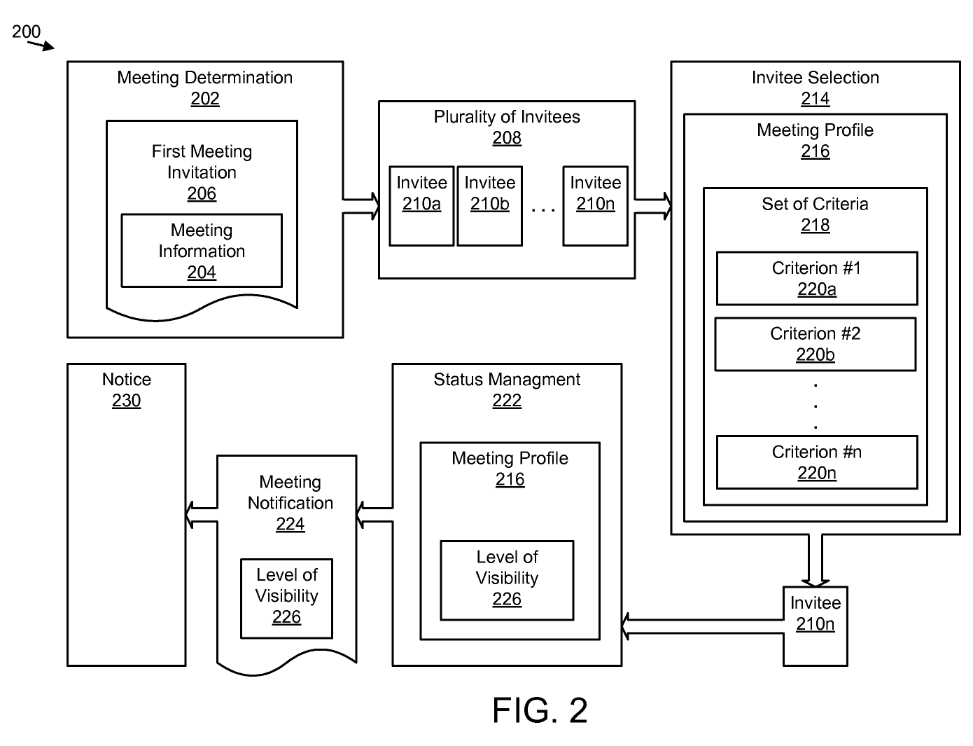

FIG. 2 depicts one embodiment of a computer program product 200 for management of meeting-status information sharing in accordance with the present invention. The computer program product 200 includes a meeting determination module 202, an invitee selection module 214, a status management module 222, and a notice module 230 substantially similar to the meeting determination module 110, the invitee selection module 112, the status management module 114, and the notice module 116 discussed above with respect to FIG. 1, except that they will be discussed in greater detail and in additional embodiments with respect to FIG. 2. The various components of the computer program product 200 cooperate to allow an invitee 210 to a meeting to control the distribution of information about the invitee's 210 posture with respect to the meeting to other invitees 210.

The meeting determination module 202 accesses meeting information 204 from a first meeting invitation 206. From the meeting information 204, the meeting determination module 202 determines a plurality of invitees 208 comprised of however many invitees 210a-210n are invited to the meeting. In certain embodiments, the meeting determination module generates the plurality of invitees 208 from meeting information 204 provided to a special interface (not shown) that constitutes the first meeting invitation 206. In certain embodiments, the meeting determination module 202 generates the plurality of invitees 208 indirectly from email address entered into the send and carbon copy fields of the first meeting invitation 206. Other approaches to determining invitees 210a-210n that comprise the plurality of invitees 208 will be readily apparent to those of ordinary skill in the art in light of this disclosure.

The invitee selection module 214 selects a second invitee 210n or multiple invitees 210 from the plurality of invitees 208 based on criteria in a meeting profile 216 unique to a first invitee 210. The criteria in the meeting profile 216 comprise a set of criteria rules 218, comprised of at least one criterion rule 220a-220n. The criterion rules 220a-220n that make up the set of criteria rules 218 are selected by the first invitee 210 from a group of criterion rules displayed to the first invitee 210 by an interface used to define the meeting profile 216. Many embodiments include a unique meeting profile 216 for multiple invitees 210. In certain embodiments, the set of criteria rules 218 is an ordered set.

An ordered set assigns hierarchical priority to criterion rules 220a-220n relative to their ordering, or position, in the set. Specifically exceptions to criterion rules 220 appearing earlier in the set are made by criterion rules 220 appearing later in the set. In such embodiments, the first invitee 210 may select a first criterion rule 220a and a second criterion rule 220b, wherein the second criterion rule 220b qualifies the first criterion rule 220a. Similarly, the first invitee 210 may select an additional criterion rule 220n that qualifies the first criterion rule 220a and the second criterion rule 220b and so on, any number of times. For example, a first criterion rule 220a to include all invitees could be qualified by a second criterion rule 220b to exclude a particular invitee.

In one embodiment, an ordered list of criterion rules from which the first invitee selects may include a criterion rule 220a to either include or exclude every invitee 210 in the plurality of invitees 208. The first invitee may or may not determine to qualify the first criterion rule 220a with a second criterion rule 220b to exclude or include every invitee 210 that also belongs to a social network of the first invitee. The social network may be defined by a scheduling application 102 similar to the ones depicted in FIG. 1, by a social networking website, or in another manner recognizable to those of ordinary skill in the relevant art.

Furthermore, the first invitee may or may not determine to qualify the first criterion rule 220a, the second criterion rule 220b, or both, with a third criterion rule 220c. The third criterion rule 220c either includes or excludes every invitee 210 that shares a common role at the meeting. A meeting role may be defined as presenting, speaking, facilitating, presiding, merely attending, or any other responsibility commonly associated with a meeting. The first invitee also may or may not determine to qualify the first criterion rule 220a, the second criterion rule 220b, the third criterion rule 220c, or any combination of them, with a fourth criterion rule 220d. The fourth criterion rule 220d either excludes or includes every invitee 210 having a common attribute. The common attribute may be recorded by a scheduling application 102 similar to the ones depicted in FIG. 1, by a network profile, or by a website, or by any other entity recognizable to those of ordinary skill in the relevant art. The common attribute may be a position, office, or responsibility within a company, a skill, an interest, a personal characteristic, a title, a degree, or any other distinguishing characteristic recognizable to those of ordinary skill in the relevant art in light of this disclosure. Additionally, the common attribute may be a status as a mandatory or optional attendee.

Additionally, the first invitee also may or may not determine to qualify the first criterion rule 220a, the second criterion rule 220b, the third criterion rule 220c, the fourth criterion rule 220d, or any combination of them, with a fifth criterion rule 220e. The fifth criterion rule 220d either includes or excludes every invitee 210 that meets a condition set by the first invitee. The condition may address whether other invitees 210 accept or decline to attend the meeting or the level of visibility (as discussed above with respect to FIG. 1) provided by the invitees in meeting invitations 206 sent to the first invitee. Other useful conditions are possible, as apparent to those of ordinary skill in the art in light of this disclosure. The first invitee also may or may not determine to qualify the first criterion rule 220a, the second criterion rule 220b, the third criterion rule 220c, the fourth criterion rule 220d, the fifth criterion rule 220e, or any combination of them, with a sixth criterion rule 220f that includes or excludes at least one particular individual invitee 210n from the plurality of invitees 208. In certain embodiments, the ordered set includes at least one example of the first criterion rule 220a, the second criterion rule 220b, the third criterion rule 220c, the fourth criterion rule 220d, the fifth criterion rule 220e, and the sixth criterion rule 220f.

The status management module 222 associates a level of visibility 226 for the first invitee 210 relative to the meeting with a meeting notification 224 for each invitee 210 selected by the invitee selection module 214. Each meeting notification 224 discloses a level of visibility 226 of the first invitee relative to the meeting. The first invitee sets the level of visibility 226 through an interface (not shown) provided to the meeting profile 216 to comprise one or more of visibility of the first invitee's listing as an invitee to the meeting, visibility of the first invitee's attendance status with respect to the meeting (indicating whether the first invitee has accepted the invitation, declined the invitation, or, in certain embodiments, is likely or unlikely to attend), and visibility of the first invitee's role at the meeting.

The notice module 230 provides the level of visibility 226 associated with the meeting notification 224 by the status management module 222 to the selected invitee 210n, or multiple selected invitees 210, or provides multiple levels of visibility 226 for multiple invitees 210 associated with multiple meeting notifications 224 by the status management module 222 to their corresponding, selected invitees 210. In certain embodiments, the notice module 230 provides the selected invitee 210n with the generated message through the email client 120b (See FIG. 1) of a scheduling application 102b (See FIG. 1) associated with the selected invitee.

In certain embodiments, the notice module 230 provides the meeting notification 224 or meeting notifications 224 by a manner selected by the first invitee 210. The first invitee may select to provide the meeting notification 224 or meeting notifications 224 automatically or in response to a meeting invitation 206. The first invitee 210 may also select to provide the meeting notification 224 or meeting notifications 224 only in response to a command from the first invitee 210 or in response to an inquiry from a second invitee 210 or group of invitees 210. Also, the first invitee 210 may select to provide the meeting notification 224 or meeting notifications 224 in response to an update of the first invitee's 210 level of visibility 226 or in response to a change of the first invitee's 210 attendance status. The first invitee 210 may also select a frequency with which the meeting notification 224 or meeting notifications 224 are provided, including any updates or changes, for example on a daily basis. The first invitee 210 may select a combination of manners for providing the meeting notification 224 or notifications 224, and the possible manners for providing the second meeting notification 224 or meeting notifications 224 may include additional manners apparent to those of ordinary skill in the art in light of this disclosure. In certain embodiments, the selected manner, manners, or frequency for providing the meeting notifications 224 or meeting notifications 224 are recorded in the meeting profile 216.

In certain embodiments, the meeting profile 216 is configured by the first invitee 210 as a default meeting profile 216. Additionally, the meeting profile 216 may be defined by the first invitee 210 in response to a particular meeting invitation 206 or a particular type of meeting invitation 206. Furthermore, the meeting profile 216 may be defined by the first invitee 210 for all meetings to which a particular invitee 210 is invited. Additionally, a meeting profile 216 may be defined for all meetings created by a particular meeting organizer. Additional approaches to defining a meeting profile 216 will be apparent to those of ordinary skill in the art in light of this disclosure.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable storage medium having computer usable program code executable to perform operations that allow an invitee to a meeting to control the distribution of information about the invitee's posture with respect to the meeting to other invitees to the meeting, the computer program product comprising:
a meeting determination module that determines a plurality of invitees to a meeting from information in a first meeting invitation to a first invitee to the meeting defined by a meeting organizer;
an invitee selection module that selects, for purposes of determining to whom to disclose information about the first invitee relative to the meeting, a second invitee to the meeting from the plurality of invitees to the meeting based on criteria in a meeting profile unique to the first invitee, the criteria comprising a set of criteria rules determined by the first invitee from a group of criteria rules;
a status management module that associates a level of visibility of the first invitee relative to the meeting with a second meeting invitation to the second invitee, wherein the level of visibility is set by the first invitee in the meeting profile and comprises one or more of visibility of the first invitee's listing as an invitee to the meeting, visibility of the first invitee's attendance status with respect to the meeting, and visibility of the first invitee's role at the meeting; and
a notice module that provides the second meeting invitation to the second invitee by a manner selected from a group consisting of automatic, in response to a command from the first invitee, in response to an inquiry from the second invitee, in response to an update of the level of visibility, and in response to a change of the first invitee's attendance status.

2. The computer program product of claim 1, wherein the second meeting invitation comprises an icon indicative of a social network relationship between the first invitee and the second invitee.

3. The computer program product of claim 1, wherein the group of criteria rules comprises an ordered set of criteria rules determined by the first invitee from a group of criteria rules comprising: including every invitee in the plurality of invitees excepting invitees excluded by subsequent criteria rules in the ordered set of criteria rules, excluding every invitee from the plurality of invitees excepting invitees included by subsequent criteria rules in the ordered set of criteria rules, including every invitee of the plurality of invitees also belonging to a social network of the first invitee excepting invitees excluded by subsequent criteria rules in the ordered set of criteria rules, excluding every invitee of the plurality of invitees also belonging to a social network of the first invitee excepting invitees included by subsequent criteria rules in the ordered set of criteria rules, including every invitee of the plurality of invitees that shares a role at the meeting excepting invitees excluded by subsequent criteria rules in the ordered set of criteria rules, excluding every invitee of the plurality of invitees that shares a common role at to the meeting excepting invitees included by subsequent criteria rules in the ordered set of criteria rules, including every invitee having a common attribute excepting invitees excluded by subsequent criteria rules in the ordered set of criteria rules, excluding every invitee having a common attribute excepting invitees included by subsequent criteria rules in the ordered set of criteria rules, including every invitee who has met a condition defined by the first invitee excepting invitees excluded by subsequent criteria rules in the ordered set of criteria rules, excluding every invitee who has met a condition defined by the first invitee excepting invitees included by subsequent criteria rules in the ordered set of criteria rules, including a particular individual invitee selected by the first invitee from the plurality of invitees, and excluding a particular individual invitee selected by the first invitee from the plurality of invitees.

4. The computer program product of claim 1, wherein the meeting profile is one member of the group consisting of a meeting profile defined by the first invitee as a default meeting profile, a meeting profile defined by the first invitee in response to a particular meeting invitation, a meeting profile defined by the first invitee for a particular type of meeting invitation, a meeting profile defined by the first invitee for all meetings to which a particular invitee is invited, and a meeting profile defined for all meetings created by a particular meeting organizer.

5. The computer program product of claim 1, wherein the meeting profile allows the first invitee to select a second invitee, based on the second invitee belonging to a particular group or social network, to receive a request for an update from the notice module in the event that the second invitee should change at least one member of the group consisting of the second invitee's posture with respect to the meeting and the second invitee's level of visibility with respect to the first invitee.

6. A system for allowing an invitee to a meeting to control the distribution of information about the invitee's posture with respect to the meeting to other invitees to the meeting, the system comprising:
a first scheduling application pertaining to a first invitee to a meeting, the first scheduling application residing in a computer readable storage memory and executed by a processor;
a second scheduling application pertaining to a second invitee to the meeting, the scheduling application residing in a computer readable storage memory and executed by a processor;
a meeting determination module coupled to a server that determines a plurality of invitees to the meeting from information in a first meeting invitation to the first invitee to the meeting defined by a meeting organizer;
an invitee selection module coupled to the server that selects the second invitee to the meeting from the plurality of invitees to the meeting based on criteria in a meeting profile unique to the first invitee, the criteria comprising an ordered set of criteria rules determined by the first invitee from a group of criteria rules comprising: including every invitee in the plurality of invitees excepting invitees excluded by subsequent criteria rules in the ordered set of criteria rules, excluding every invitee from the plurality of invitees excepting invitees included by subsequent criteria rules in the ordered set of criteria rules, including every invitee of the plurality of invitees also belonging to a social network of the first invitee excepting invitees excluded by subsequent criteria rules in the ordered set of criteria rules, excluding every invitee of the plurality of invitees also belonging to a social network of the first invitee excepting invitees included by subsequent criteria rules in the ordered set of criteria rules, including every invitee of the plurality of invitees that shares a role at the meeting excepting invitees excluded by subsequent criteria rules in the ordered set of criteria rules, excluding every invitee of the plurality of invitees that shares a common role at to the meeting excepting invitees included by subsequent criteria rules in the ordered set of criteria rules, including every invitee having a common attribute excepting invitees excluded by subsequent criteria rules in the ordered set of criteria rules, excluding every invitee having a common attribute excepting invitees included by subsequent criteria rules in the ordered set of criteria rules, including every invitee who has met a condition defined by the first invitee excepting invitees excluded by subsequent criteria rules in the ordered set of criteria rules, excluding every invitee who has met a condition defined by the first invitee excepting invitees included by subsequent criteria rules in the ordered set of criteria rules, including a particular individual invitee selected by the first invitee from the plurality of invitees, and excluding a particular individual invitee selected by the first invitee from the plurality of invitees;
a status management module coupled to the server that associates a level of visibility of the first invitee relative to the meeting, as set by the first invitee in the meeting profile, with a second meeting invitation to the second invitee;
a notice module coupled to the server that provides the second meeting invitation to the second invitee; and
a network connecting the first scheduling application, the second scheduling application, and the server.

7. The system of claim 6, wherein the level of visibility comprises one or more of visibility of the first invitee's listing as an invitee to the meeting, visibility of the first invitee's attendance status with respect to the meeting, and visibility of the first invitee's role at the meeting.
